(19) United States
(12) Patent Application Publication
(10) Pub. No.: US 2019/0147376 A1
(43) Pub. Date: May 16, 2019

(54) METHODS AND SYSTEMS FOR RISK DATA GENERATION AND MANAGEMENT

(71) Applicant: Tracker Networks Inc., Toronto (CA)

(72) Inventors: Roger Ramchand Mahabir, Toronto (CA); Jason Doel, Newmarket (CA); Mesbah Abdulrahem, Guelph (CA); Peter Grys, Richmond Hill (CA); Peter H. Ritchie, Toronto (CA)

(21) Appl. No.: 15/810,870

(22) Filed: Nov. 13, 2017

(51) Int. Cl. G06Q 10/06

(52) U.S. Cl. CPC G06Q 10/0635

(57) ABSTRACT

Risk data generation for an organizational network involves a risk assessment server that communicates with organizational computing devices. The server transmits risk data request and receives responses identifying organizational risks. The server generates and transmits assessment templates, and receives risk evaluation data from a plurality of computing devices in response. The server automatically generates a risk assessment score for an organizational risk based on the values in the plurality of risk evaluation responses, the risk assessment score defining an expected organizational impact of that particular organizational risk and transmits the risk assessment score to an administrator. The server collects benchmark risk data and risk outcomes from similar networks and generates the scores using the benchmark data. The server also provides comparative results between similar organizational networks.

### FIELD

The described embodiments relate to managing risk data, and in particular to systems and methods for generating and managing risk data in a distributed organizational network.

### BACKGROUND

It is difficult to identify and monitor risks that can impact an organization, particularly as the organization grows and becomes distributed. It may be unfeasible or unwieldy for organizations to manually assess and analyze the risks posed to various aspects of their operations, such as cybersecurity risks and/or risks posed by internal and external operational influences. Ongoing monitoring of potential risks and risk factors can become particularly unfeasible as organizations grow and the risk factors become associated with different areas and users in an organizational network.

Organizations may also not have the internal expertise and personnel required to perform this assessment. For instance, an organization may be required to track and assess hundreds of risks such that manually tracking and assessing risks is not feasible. Similarly, manually tracking and assessing underlying risk data for risks that are associated with different areas or locations within the organizational network can become unfeasible. Maintaining an up-to-date assessment of the risk data similarly becomes an unfeasible task given the breadth and scope of risk data needed to be collected, processed and analyzed.

As a result, organizational risk assessments tend to use outdated and incomplete risk data. This can result in an inaccurate assessment of the organizational risk profile. Additionally, as organizations may lack the internal expertise and personnel to perform these assessments, the analysis of the underlying risk data may itself be flawed.

### SUMMARY

In a first broad aspect, there is provided a method of analyzing risk data for an organizational network. The method can include providing a risk assessment server for monitoring organizational risk, the risk assessment server having a processor and a memory and being in communication with a plurality of computing devices associated with the organizational network including a plurality of user devices; transmitting, by the risk assessment server, a risk data request to each of the user devices in the plurality of user devices; receiving, by the risk assessment server a plurality of risk data responses from the user devices, each risk data response identifying a particular organizational risk and defining a plurality of risk attributes associated with the particular organizational risk; for at least one of the particular organizational risks, defining by the risk assessment server, a risk assessment score by generating, by the risk assessment server, a risk evaluation template for that particular organizational risk, the risk evaluation template defining a plurality of risk assessment criteria based on the plurality of risk attributes associated with that particular organizational risk; transmitting, by the risk assessment server, the risk evaluation template to a plurality of assessment user devices in the plurality of users devices; receiving, by the risk assessment server from the plurality of assessment user devices, a plurality of risk evaluation responses, each risk evaluation response including user-specific values for the plurality of risk assessment criteria in the risk evaluation template; automatically generating, by the risk assessment server, a risk assessment score for the particular organizational risk based on the user-specific values in the plurality of risk evaluation responses, the risk assessment score defining an expected organizational impact of that particular organizational risk; and transmitting the risk assessment score for the particular organizational risk to at least one of the user devices.

In some embodiments, automatically generating the risk assessment score may include determining a predicted risk occurrence value from the user-specific values in the plurality of risk evaluation responses, the predicted risk occurrence value indicating an estimated likelihood of that organizational risk occurring; determining a predicted risk impact value from the user-specific values in the plurality of risk evaluation responses, the predicted risk impact value indicating an estimated organizational impact of that organizational risk occurring; generating an inherent risk value from the predicted risk occurrence value and the predicted risk impact value; determining an implemented control value from the user-specific values in the plurality of risk evaluation responses, the implemented control value indicating a level of organizational control implemented to prevent the occurrence of that organizational risk; modifying the inherent risk value based on the control value to generate a residual risk value; and generating the risk assessment score from the residual risk value.

In some embodiments, the risk assessment server may be configured to store a risk tolerance for each of the particular organizational risks in the memory, and the method may further include comparing, by the risk assessment server for each particular organizational risk, the risk assessment score determined for that particular organizational risk and the stored risk tolerance; identifying, by the risk assessment server, a risky organizational risk as an organizational risk in the at least one particular organizational risk having a risk assessment score that exceeds the stored risk tolerance for that organizational risk; transmitting a high risk notification to the at least one user device, the high risk notification identifying the risky organizational risk.

In some embodiments, the method may include, for at least one of the particular organizational risks: identifying, by the risk assessment server, a plurality of risk indicators; for at least one of the risk indicators identifying, by the risk assessment server, one or more computing devices in the plurality of computing devices that stores risk indicator data associated with that risk indicator; remotely monitoring, by the risk assessment server, the stored risk indicator data on the one or more computing devices; identifying, by the risk assessment server, a change in the risk indicator based on the monitoring; automatically adjusting, by the risk assessment server, the risk assessment score for the particular organizational risk in response to the identified change in the risk indicator; and transmitting the adjusted risk assessment score to the at least one of the user devices.

In some embodiments, the method may include, for a second risk indicator: identifying, by the risk assessment server, one or more users associated with risk indicator data for that second risk indicator; for each of the one or more users identified, repeatedly transmitting, by the risk assessment server to a user device associated with that user, a risk indicator data request identifying the second risk indicator and defining the requested risk indicator data; receiving, by the risk assessment server, a risk indicator data response from the user device associated with at least one of the one or more users; identifying, by the risk assessment server from the received risk indicator data response, a change in the second risk indicator; automatically adjusting, by the risk assessment server, the risk assessment score for the particular organizational risk in response to the identified change in the second risk indicator; and transmitting the adjusted risk assessment score to the at least one of the user devices.

In some embodiments, the risk assessment server may be in communication with at least one database storing a plurality of previously identified organizational risks; the risk data request can identify at least some of the previously identified organizational risks and provides a new risk definition template; and the particular organizational risk identified in one of the risk data responses received by the risk assessment server may be a user-generated organizational risk that does not correspond to any of the previously identified organizational risks defined using the new risk definition template.

In some embodiments, the method may include updating, by the risk assessment server, the plurality of previously identified organizational risks stored on the database to include the user-generated organizational risk.

In some embodiments, the method may include determining, by the risk assessment server, a risk type of the user-generated organizational risk based on the plurality of risk attributes associated with that user-generated organizational risk; determining, by the risk assessment server, that the determined risk type is also associated with at least one of the previously identified organizational risks; and pre-populating, by the risk assessment server, some of the risk assessment criteria in the risk evaluation template for that user-generated organizational risk based on the determined risk type.

In some embodiments, the method may include identifying, by the risk assessment server, at least one unique organizational risk from the plurality of risk data responses by: determining, by the risk assessment server, that the particular organizational risks identified in at least two of the risk data responses correspond to the same organizational risk; and identifying a particular unique organizational risk by correlating the organizational risks identified in the at least two risk data responses whereby the risk attributes associated with the particular unique organizational risk are defined by combining the risk attributes associated with the organizational risks identified in the at least two risk data responses; and the at least one of the particular organizational risks for which a risk assessment score is defined is determined based on the at least one unique organizational risks identified.

In some embodiments, the risk assessment server may be in communication with at least one database storing user profiles associated with the user devices, and the method may include, for each particular organizational risk: determining, by the risk assessment server, a risk type of that particular organizational risk based on the plurality of risk attributes associated with that particular organizational risk; and identifying the plurality of assessment user devices for that particular organizational risks by identifying user profiles associated with that determined risk type.

In some embodiments, generating the risk assessment score for the identified organizational risk may include weighting the plurality of risk evaluation responses based on a user weighting associated with each of the corresponding assessment users.

In some embodiments, the risk assessment server may be in communication with a plurality of additional organizational networks, and the method may include: receiving, by the risk assessment server from each of the additional organizational networks, risk outcome data defining an outcome of previously identified organizational risks associated with that additional organizational network; determining that at least one of the particular organizational risks corresponds to one of the previously identified organizational risks; and generating the risk assessment score for the at least one of the particular organizational risks may be based on risk outcome data associated with the corresponding previously identified organizational risks from the additional organizational networks.

In some embodiments, the risk assessment server may be in communication with a plurality of additional organizational networks and at least one database storing organizational profiles corresponding to the organizational network and each of the additional organizational network, and the method may include: determining, by the risk assessment server, at least one similar organizational network from the plurality of additional organizational networks from the organizational profiles, each similar organizational network having an organizational profile similar to that of the organizational network; determining, by the risk assessment server for at least one of the particular organizational risks, a similar network risk assessment score for that particular organizational risk in each of the similar organizational networks; determining, by the risk assessment server for the organizational network, a relative risk assessment score for the at least one particular organizational risk by comparing the generated risk assessment score and the determined similar network risk assessment scores; and transmitting the relative risk assessment score to the at least one of the user devices.

In some embodiments, the risk assessment server may be in communication with a plurality of additional organizational networks and at least one database storing organizational profiles corresponding to the organizational network and each of the additional organizational network, and the method may include: determining, by the risk assessment server, at least one similar organizational network from the plurality of additional organizational networks from the organizational profiles, each similar organizational network having an organizational profile similar to that of the organizational network; identifying, by the risk assessment server for the organizational network, at least one potential additional organizational risk based on previously identified organizational risks associated with the similar organizational networks; and transmitting the at least one potential additional organizational risk to the at least one user device.

In some embodiments, the method may further include storing the risk assessment score for each of the particular organizational risks in the memory; repeatedly updating, by the risk assessment server, the risk assessment score defined for the at the at least one particular organizational risk; and storing each updating risk assessment score in the memory.

### BRIEF DESCRIPTION OF THE DRAWINGS

A preferred embodiment of the present invention will now be described in detail with reference to the drawings, in which:

FIG. 1 is a block diagram of a distributed risk management system for a plurality of organizational networks in accordance with an example embodiment;

FIG. 2 is a block diagram of an organizational risk management system in accordance with an example embodiment;

FIG. 3 is a flowchart illustrating a method of identifying risk data for an organizational network in accordance with an example embodiment;

FIG. 4 is a flowchart illustrating a method of analyzing risk data for an organizational network in accordance with an example embodiment;

FIG. 5 is a flowchart illustrating a sub-process for generating a risk assessment score for an organizational network in accordance with an example embodiment;

FIG. 6 is a flowchart illustrating a method of analyzing risk data for a plurality of organizational networks in accordance with an example embodiment;

FIG. 7 illustrates an example network risk assessment display in accordance with an example embodiment;

FIG. 8 illustrates an example detailed risk display in accordance with an example embodiment;

FIG. 9 illustrates an example network risk overview display in accordance with an example embodiment;

FIG. 10A illustrates an example risk data collection request message in accordance with an example embodiment;

FIG. 10B illustrates an example risk data collection response message in accordance with an example embodiment;

FIG. 11 illustrates an example comparative network risk display in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXEMPLARY EMBODIMENTS

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

Many organizational networks lack the internal expertise and/or personnel to effectively monitor organizational risks. Often, an administrator manually tracks known organizational risks using spreadsheet-based risk registers. However, this process requires significant expertise and oversight and often results in the organization tracking only risk events that have previously occurred or that the administrator is personally familiar with. As a result, many important organizational risks may be omitted during the risk identification and collection process.

Manual monitoring and tracking of organizational risk is also limited to risk data immediately accessible to the administrator or administrators performing the tracking. Administrators often lack access to comparative data from similar organizational networks within the same field or industry. This limited risk data is used by the administrator when subjectively assessing the likelihood and/or potential impact of a risk occurring. However, given the limited data available to an administrator, and their often limited experience, these risk assessments can be misleading and potentially inaccurate.

Furthermore, administrators may rely on these assessments and the limited risk data to identify and select preventative actions intended limit or reduce the likelihood and/or potential impact of an organizational risk. Accordingly, organizations may select inappropriate or inefficient preventative actions, which may ultimately result in harm to the organizational network, or increased harm as compared to more appropriate preventative actions.

Furthermore, a manual tracking process lacks the ability to monitor changes in organizational risks and underlying risk factors at a granular level. Changes to the underlying risk data, and corresponding changes to the assessments of organizational risks may also occur without oversight and/or notification. This may undermine the integrity of the risk data being assessed. This may also result in changes in risk assessments being identified too late to implement effective preventative actions.

Embodiments described herein may address various issues associated with previous approaches to monitoring and assessing organizational risk data. For instance, embodiments described herein may provide improved processes for collecting risk data and monitoring underlying risk indicator data. This may ensure that assessments of organizational risks take into account most, if not all, of the risk data that can meaningfully impact the organizational risk.

Embodiments of the systems and methods described herein may facilitate risk management for organizational networks. In particular, embodiments of the systems and methods described herein may provide increased awareness and a greater understanding of risks posed to the organizational network by various internal and external risk factors. Embodiments of the systems and methods described herein may also provide an improved ability to monitor underlying risk indicator data associated with organizational risks to identify and track changes in the organizational risks.

The embodiments described herein may provide a comprehensive identification and assessment of the risks posed to an organizational network. This may allow administrators to mitigate risks to the organizational network, e.g. by implementing preventative actions (also referred to as mitigations) or modifying ongoing preventative actions.

A risk assessment server may automatically trigger risk data collection from users associated with various organizational risks. The risk assessment server may trigger risk data collection processes on an ongoing basis to ensure that risk data being assessed is accurate and up-to-date.

Embodiments described herein may facilitate the identification and definition of organizational risks for an organizational network. A risk assessment server may collect risk data from a plurality of organizational networks. Risk data collected from similar organizational networks may be used to identify additional organizational risks and/or assess the organizational risks for a particular organizational network.

Embodiments described herein may also provide improved systems and processes for collecting user risk assessments associated with identified organizational risks. For instance, embodiments described herein may automatically generate risk assessment templates to collect risk assessment data from relevant users within the organizational network.

Some embodiments described herein may also identify underlying risk indicator data (corresponding to organizational risks) that is stored on computing devices within the organizational network. The risk assessment server may automatically retrieve this risk indicator data to update the corresponding risk assessments. This risk data monitoring and retrieval can occur on an ongoing basis to ensure that organizational risk assessments are accurate.

The risk assessment server may also trigger risk indicator data notifications to users associated with risk indicator data that may not be available automatically from the computing devices. The risk assessment server can transmit risk indicator data update requests to those users to update this offline risk indicator data.

The risk assessment server can also store the risk data and risk indicator data collected for an organizational network over time. The risk assessment server may identify trends in the risk data or risk levels, and can generate notifications to administrator users that particular organizational risks appear to be increasing. This tracking may also provide audit data to allow administrator users to track and identify when and where risk data changes have occurred.

Embodiments described herein may also provide improved systems and methods for assessing organizational risks. Embodiments described herein may analyze the collected risk assessment data and/or risk indicator data to generate risk assessment scores for the organizational risks. These risk assessments scores can be transmitted to corresponding administrator users to notify them of the risk levels associated with various organizational risks.

Embodiments described herein may continually update the risk assessments based on updated risk indicator data. This may ensure that system administrators can be notified on an on-going basis of organizational risk levels and any changes thereto.

In some cases, the risk assessment server may also include an escalating notification system. The risk assessment server may transmit risk assessment scores to additional users as risk levels increase.

The risk assessment server may also compare risk assessment scores collected from similar organizational networks to provide administrator users with comparative risk assessments. The risk assessment server can identify benchmark risk levels and risk scores for a particular organization type and display that benchmark data to administrator users to provide context for their risk assessment scores. This context may assist those administrator users in determining the appropriate preventative actions to undertake.

Furthermore, the risk assessment server can identify potential preventative actions for the administrator users based on preventative actions implemented in similar organizational networks. For example, the risk assessment server may identify preventative actions associated with positive risk outcomes and display those to the administrator user. This may provide the administrator user with additional preventative actions to implement rather than requiring skill and expertise to identify and implement appropriate preventative actions.

When an administrator implements preventative actions, the risk assessment server can automatically transmit action notifications to the users associated with the preventative actions. The risk assessment server can automatically transmit action item update notifications to those users on a periodic basis to determine the status of the action item. This ensures that action items are undertaken promptly and with increased diligence.

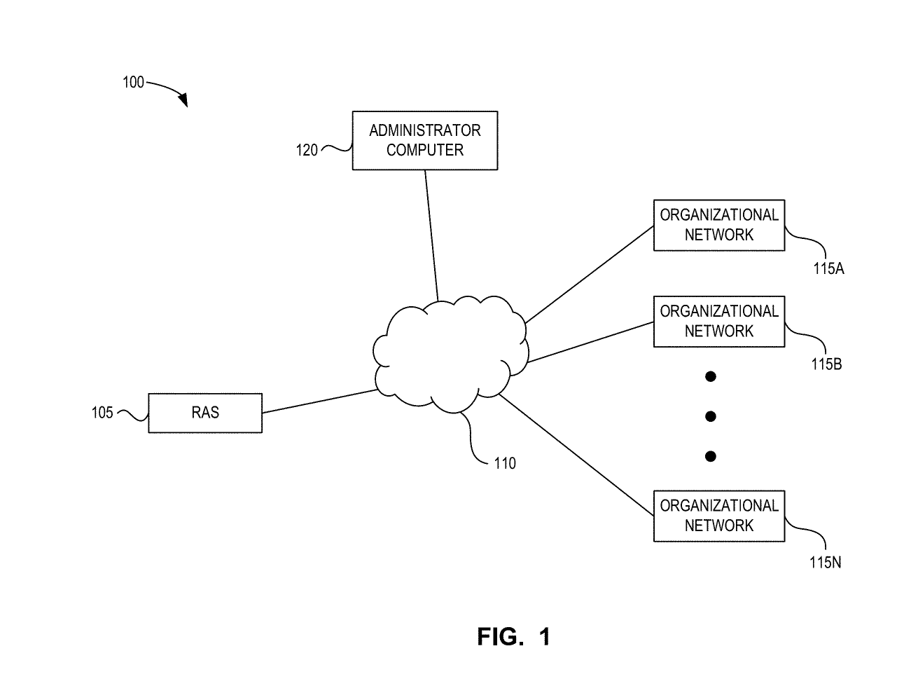

Referring now to FIG. 1, there is provided is a block diagram of a risk management computer network system 100 in accordance with an example embodiment. Risk management system 100 is configured to provide monitoring and analysis of organizational risks and risk data for a plurality of organizational networks 115A-115N.

Computer network system 100 generally comprises a plurality of computers connected via data communication network 110, which itself may be connected to the Internet. In general, however, the computer network system 100 includes a risk assessment server (RAS) 105, one or more administrator computers 120, and a plurality of organizational networks 115A-115N (each comprising a plurality of computing devices) connected via network 110.

Typically, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Computers and computing devices may be connected to network 110 or a portion thereof via suitable network interfaces. Computing devices may also encompass any connected or “smart” devices capable of data communication, such as thermostats, air quality sensors, industrial equipment and the like. Increasingly, this encompasses a wide variety of devices as more devices become networked through the “Internet of Things”. In some cases, one or more of the computing devices such as the computing devices in organizational networks 115 may connect to network 110 via the Internet.

Examples of computers include the remote administrator computer 120, such as a desktop or laptop computer, which can connect to network 110 via a wired Ethernet connection or a wireless connection. The remote administrator computer 120 may also connect to the network 110 via the Internet. Remote administrator computer 120 has a processor, volatile memory and non-volatile storage memory, at least one network interface, input devices such as a keyboard and trackpad, output devices such as a display and speakers, and various other input/output devices as will be appreciated.

As with all devices shown in computer network system 100, there may be multiple administrator computers 120, although not all are shown. For instance, each organizational network 115 may have one or more organizational administrator computers.

Similarly, the computing devices associated with organizational networks 115 can include various computing devices, such as smartphones, desktop, laptop or tablet computers, however the computing devices may also include a wide variety of “smart” devices capable of data communication. Like computer 120, the computing devices associated with organizational networks 115 have a processor, volatile and non-volatile memory, at least one network interface, and input/output devices. Each of the computers and computing devices may at times connect to external computers or servers via the Internet.

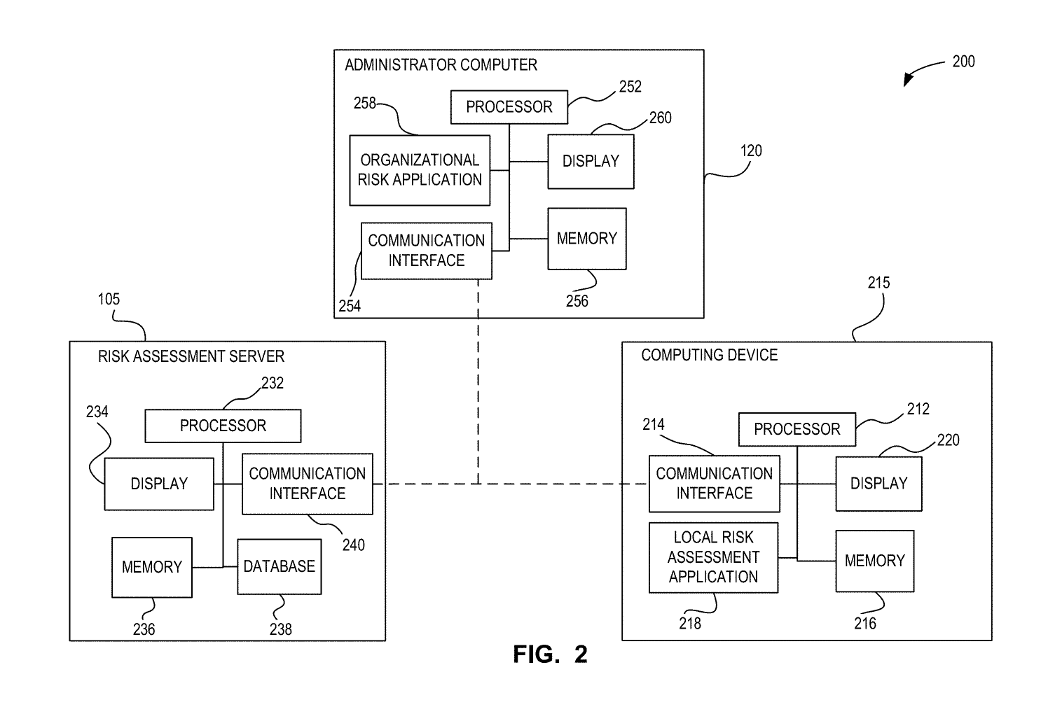

Risk assessment server 105 is a computer or computer server, and has a processor, volatile and non-volatile memory, at least one network interface, and may have various other input/output devices. As shown, risk assessment server 105 is linked to network 110. However, in other embodiments, risk assessment server 105 may be outside network 110 and linked to the Internet. The risk assessment server 105, administrator computer 120 and a computing device 215 associated with one of the organizational networks 115 are described in greater detail with reference to FIG. 2 below.

Risk assessment server 105 may be configured to collect, analyze, and monitor risk data associated with each of the organizational networks 115. For instance, risk assessment server 105 may collect risk data related to strategic, operational, market, liquidity, credit and other organizational risks for each organizational network 115.

As used herein, the term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs. For example, for many organizations, important applications and services rely on regular input from spreadsheets that may be obtained from third parties, so these spreadsheets may be identified as software applications.

Referring now to FIG. 2, there is shown a block diagram of a risk assessment system 200 in accordance with an example embodiment. Risk assessment system 200 is an example of an organizational risk management system for one of the organizational networks 115 shown in FIG. 1.

Risk assessment system 200 is constructed from risk assessment server (RAS) 105, an administrator computer 120 and at least one computing device 215 associated with the organizational network 115. In some cases, the administrator computer 120 may be omitted from organizational risk assessment system 200, for instance where no independent administrator computer 120 is provided for that organization. In some other cases, the administrator computer 120 and RAS 105 may be integrated or co-located. In some cases, the administrator computer 120 may be provided by one of the computing devices 215 but associated with a user having administrative privileges.

Typically, the RAS 105 will be in communication with a plurality of computing devices 215 associated with the organizational network. Each of the computing devices 215 can be associated with users who perform functions associated with the organization.

RAS 105 may be directly linked to administrator computer 120, for example, via a Universal Serial Bus, Bluetooth™ or Ethernet connection. Alternatively, RAS 105 may be linked to administrator computer 120 via network 110 or, in some cases, the Internet. RAS 105 may also be linked to computing devices 215 via network 110 or, in some cases, the Internet.

RAS 105 has a processor 232, a display 234, a memory 236, a communication interface 240 and a database 238. Although shown as separate elements, it will be understood that database 238 may be stored in memory 236.

Processor 232 is a computer processor, such as a general purpose microprocessor. In some other cases, processor 232 may be a field programmable gate array, application specific integrated circuit, microcontroller, or other suitable computer processor.

Processor 232 is also coupled to display 234, which is a suitable display for outputting information and data as needed by various computer programs. In particular, display 234 may display a graphical user interface (GUI). In some cases, the display 234 may be omitted from risk assessment server 105, for instance where the risk assessment server 105 is configured to operate autonomously. In such cases, the RAS 105 may be configurable using a computer such as the administrator computer 120 that is connected to the RAS 105. RAS 105 may execute an operating system, such as Microsoft Windows™, GNU/Linux, or other suitable operating system.

Communication interface 240 is one or more data network interface, such as an IEEE 802.3 or IEEE 802.11 interface, for communication over a network.

Processor 232 is coupled, via a computer data bus, to memory 236. Memory 236 may include both volatile and non-volatile memory. Non-volatile memory stores computer programs consisting of computer-executable instructions, which may be loaded into volatile memory for execution by processor 232 as needed. It will be understood by those of skill in the art that references herein to RAS 105 as carrying out a function or acting in a particular way imply that processor 232 is executing instructions (e.g., a software program) stored in memory 236 and possibly transmitting or receiving inputs and outputs via one or more interface. Memory 236 may also store data input to, or output from, processor 232 in the course of executing the computer-executable instructions. As noted above, memory 236 may also store database 238.

In some example embodiments, database 238 is a relational database. In other embodiments, database 238 may be a non-relational database, such as a key-value database, NoSQL database, or the like. The database 238 may store risk data that can be accessed and used by the RAS 105 to identify and analyze organizational risks.

For example, the database 238 may store a plurality of previously identified organizational risks. The previously identified organizational risks stored in database 238 may include organizational risks previously identified in association with one of the organizational networks. Additionally or alternatively, the previously identified organizational risks can include administrator-defined organizational risks that can be defined by a user of administrator computer 120.

The RAS 105 may store a plurality of risk attributes associated with each previously identified organizational risk. Examples of risk attributes can include a risk identifier, an associated risk owner (e.g. an organizational user associated with or responsible for management of that risk; the associated risk owner may be defined as a specific user and/or a user role within the organizational network), an associated operational function related to that risk, a potential risk impact, a risk likelihood, a risk tolerance etc. When collecting risk data for a particular organizational network 115, the RAS 105 may use the stored risk attributes to determine whether the risk data collected from an organizational network 115 corresponds to a previously identified organizational risk. For example, the RAS 105 may determine that an identified organizational risk corresponds to a previously identified organizational risk (e.g. from a different organizational network) when the risk attributes of the identified organizational risk and the previously identified organizational risk have a similarity score above a pre-defined threshold.

The RAS 105 may also determine that a new, user-generated organizational risk is included in the risk data received from an organizational network. The RAS 105 may then store the user-generated organizational risk, and associated risk attributes in the database 238 to update the known, previously identified organizational risks. The RAS 105 can thus generate an extensible set of previously-identified and defined organizational risks from a plurality of different organizational networks.

The RAS 105 may also define a plurality of risk types for the various organizational risks using the stored risk attributes. Each previously identified organizational risk can be associated with a particular risk type or risk category. Grouping the organizational risks into risk types/categories may facilitate the assessment of organizational risks by pre-populating or partially pre-populating risk assessment templates for organizational risks within the same risk type/category.

The database 238 can also store a network association between each previously-identified organizational risks and each of the organizational networks 115 in which that risk was identified.

The database 238 can also store user profiles for users associated with the computing devices in each of the organizational networks 115. The user profiles may identify roles and/or permissions associated with a corresponding user. In some cases, the user profiles may also identify one or more risk types associated with that user. The risk types associated with a user may correspond to aspects of the organizational network with which that user interacts. For example, user profiles corresponding to users having IT functions in the organizational network may be associated with cybersecurity and/or device security risk types.

In some cases, the user profiles may also include a user weighting. The user weighting may represent a value used to weight risk assessments received from that user. For instance, users having a lower level of operational responsibility may be associated with lower user weightings than users having a greater level of organizational responsibility. Additionally or alternatively, user weightings may be adjusted based on the relevance of a particular risk type to that user's operational function.

In some cases, the RAS 105 may identify risk indicator data associated with the organizational risks stored in database 238 for a particular organization. The risk indicator data may be data that reflects the underlying risk factors associated or correlated with the particular organizational risk. The RAS 105 can also identify one or more computing devices and/or users that manage and/or store the risk indicator data for each organizational risk. The RAS 105 can store this risk indicator data location information in the database 238 to allow the RAS 105 to automatically monitor and collect risk indicator data on an ongoing basis.

For example, underlying risk indicator data related to potential cybersecurity breaches may include the number of user mobile devices within the organizational network 200 that are considered high-risk based on the presence of high-risk mobile applications. The RAS 105 may continually monitor the number of high-risk mobile devices to ensure that risk assessments related to cybersecurity breaches are accurate.

The database 238 may also store risk threshold data for the various organizational networks 115. The risk threshold data may include a risk tolerance threshold for each organizational risk identified for an organizational network. In some cases, the risk tolerance threshold may be defined by an administrator user in the organizational network in response to the organizational risk being identified. In some cases, the risk tolerance threshold may be defined initially by RAS 105 as a benchmark risk tolerance threshold, e.g. based on risk data collected from other similar organizational networks.

The RAS 105 may communicate with a plurality of additional organizational networks as shown in FIG. 1. The database 238 can store organizational profiles corresponding to each of the organizational networks 115. These organizational profiles may define organizational characteristics of an organizational network, such as organization size and organization sector. The organizational profiles can include, or be associated with, organizational risks previously identified for the corresponding network. The database 238 can also store risk outcomes for those previously-identified organizational risks in the organizational profiles. The RAS 105 may also aggregate the previously-identified risk and risk outcomes for multiple organizational networks in database 238.

The RAS 105 may access the organizational profiles stored in database 238 to identify similar organizational networks based on the organizational characteristics. This may facilitate identification of potential additional risks for an organizational network (e.g. based on previously identified risks associated with similar networks) and/or be used to generate risk assessment scores based on previous risk outcomes.

The RAS 105 can also store risk assessment scores for the organizational risks associated with each organizational network 115 in the database 238. The RAS 105 can monitor and update the stored risk assessment scores to allow a risk trend to be identified. The stored risk assessment scores may enable the RAS 105 to define comparative risk assessment scores for similar organizational networks.

The memory 236 on RAS 105 may store a software application referred to herein as a risk data assessment application. The risk data assessment application may be configured to collect risk data and identify organizational risks associated with an organizational network 115, and to determine and monitor risk assessment scores for those organizational risks.

Computing device 215 is generally a computer such as a desktop computer, laptop computer, smartphone or tablet or other “smart” device that may be networked through the “Internet of Things”. Computing device 215 has a processor 212, a communication interface 214 for data communication with communication interfaces 240 and 254, a display 220 for displaying a various GUIs, such as risk collection and risk data reporting GUIs for example, and a memory 216 that may include both volatile and non-volatile elements. As with RAS 105, references to acts or functions by computing device 215 imply that processor 212 is executing computer-executable instructions (e.g., a software program) stored in memory 216.

For instance, a local risk assessment application 218 may be stored on the computing device 215. Although shown separately from memory 216, it will be understood that local risk assessment application 218 may be stored in memory 216. The local risk assessment application 218 may communicate with the risk data assessment application of RAS 105 to assist the RAS 105 in collecting risk data, collecting user assessments of risk data, and providing feedback to users regarding organizational risks and risk assessment scores. Although the local risk assessment application 218 is shown as installed on computing device 215, the local risk assessment application 218 may be otherwise accessible to the computing device 215 for instance as a cloud application accessible to the computing device 215 over a network such as the Internet.

The risk data assessment application of RAS 105 may remotely monitor risk indicator data stored on the computing device 215, e.g. using the local risk assessment application 218. The local risk assessment application 218 may continually transmit the risk indicator data to the RAS 105, e.g. as changes are detected or on an intermittent basis. The local risk assessment application 218 may also display notifications generated by RAS 105, e.g. to collect risk evaluation responses and/or updated risk indicator data from a user of the computing device 215.

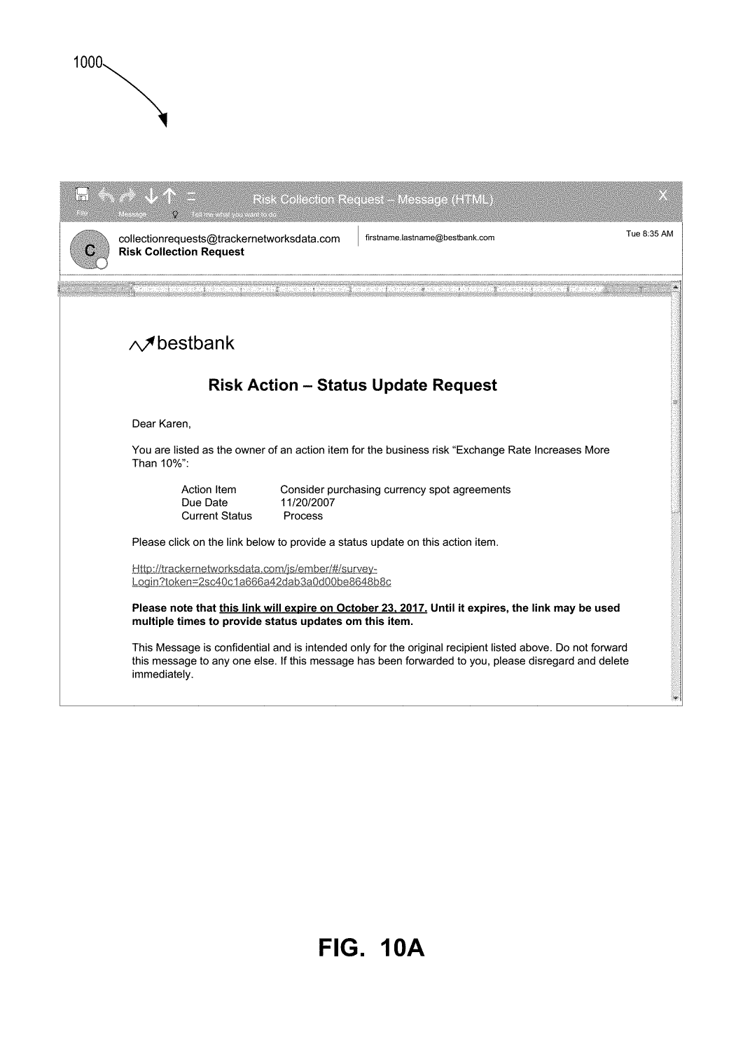

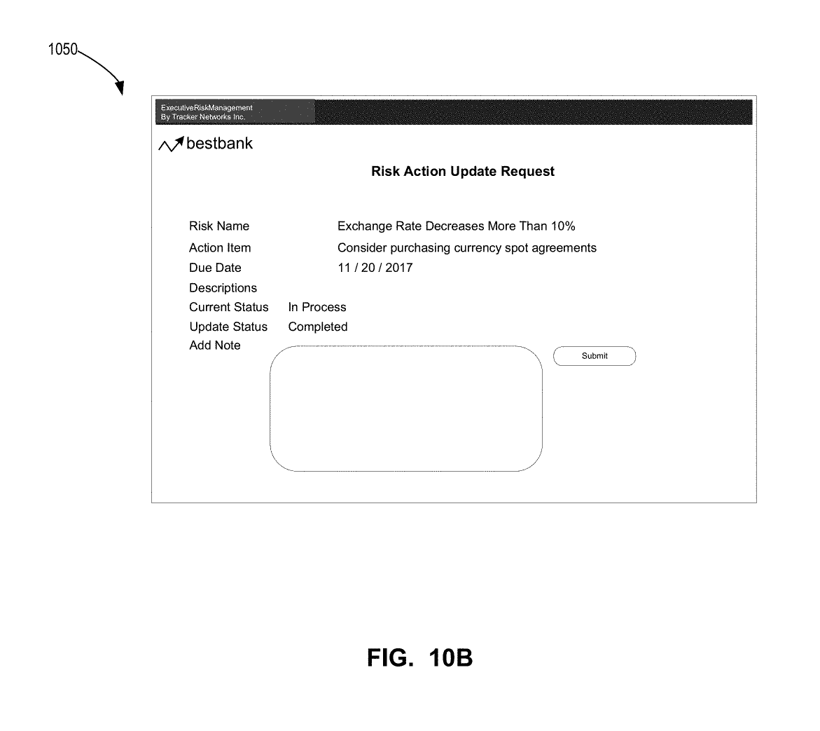

Examples of graphical user interfaces that may be displayed by local risk assessment application 218 using display 220 are discussed below with reference to FIGS. 10A and 10B.

Administrator computer 120 is generally a computer similar to risk assessment server 105. The administrator computer 120 has a processor 252, a communication interface 254 for data communication with communication interfaces 220 and 240, a display 260 for displaying an organizational risk assessment GUI, and a memory 256 that may include both volatile and non-volatile elements. As with RAS 105, references to acts or functions by administrator computer 120 imply that processor 252 is executing computer-executable instructions (e.g., a software program) stored in memory 256.

An organizational risk assessment application 258 may be stored on the administrator computer 130. Although shown separately from memory 256, it will be understood that organizational risk assessment application 258 may be stored in memory 256.

As mentioned, the administrator computer 120 may be provided by one of the computing devices 215 but associated with a user having administrative privileges. Accordingly, although the organizational risk application 258 and local risk assessment application 218 are shown as different applications, in some embodiments they may correspond to the same application albeit with different features and/or permissions for each user.

For example, the RAS 105 can store user profiles associated with a plurality of users for the organizational network 200. Each user profile can be associated with a corresponding permission level. A user may enter a distinct user ID and password combination when accessing the local risk assessment application 218 (or when accessing their computing device 215). The operations permitted through the local risk assessment application 218 or organizational risk assessment application 258 may then be adjusted based on the permission level associated with that user.

The organizational risk assessment application 258 may communicate with the risk data assessment application of RAS 105 to configure network acceptable risk tolerance thresholds, and other settings of the risk data assessment application. The RAS 105 may also monitor changes to the organizational risk settings and risk data entered by each user in association with their user ID. This change data can be stored in database 238 to allow RAS 105 and/or an administrator to identify the users associated with changes in risk data.

Although the organizational risk assessment application 258 is shown as installed on administrator computer 130, the organizational risk assessment application 258 may be otherwise accessible to the administrator computer 130 for instance as a cloud application accessible to the administrator 130 over a network such as the Internet.

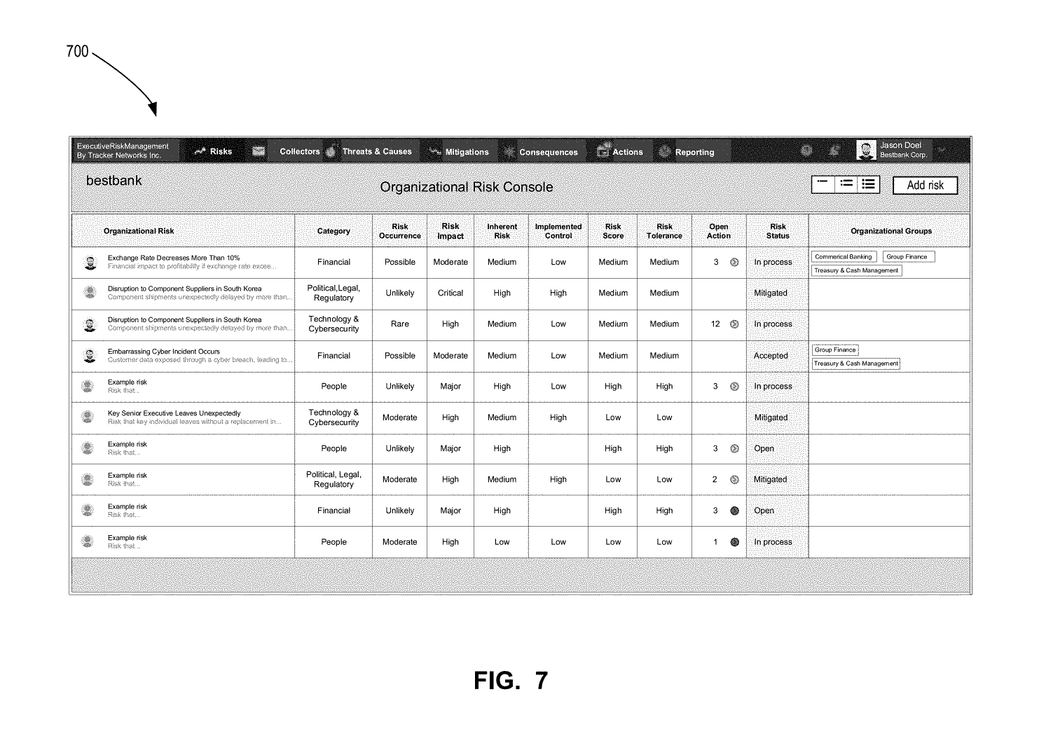

The RAS 105 may also communicate risk assessment scores and related risk data from similar organizational networks for the organizational network to the organizational risk assessment application 258. The organizational risk assessment application 258 may provide graphical user interfaces to allow an administrator of the organizational network to review risk assessment scores, comparative risk assessment scores and potential preventative actions. The organizational risk assessment application may allow the administrator to set and adjust organizational rules for allowing/preventing access to the organizational network and policies for operations within the organizational network. Examples of graphical user interfaces that may be displayed by organizational risk assessment application 258 (or local risk assessment application 218 when operated by an administrator user) using display 260 are discussed below with references to FIGS. 7, 8, 9 and 11.

The RAS 105, computing device 215 and administrator computer 120 may have various additional components not shown in FIG. 2. For example, additional input or output devices (e.g., keyboard, pointing device, etc.) may be included beyond those shown in FIG. 2.

The local risk assessment application 218 may be a downloadable application, such as a mobile application, provided by the risk assessment server 105. A user of the computing device 215 may download the local risk assessment application 218 from RAS 105 or through an app store such as the Apple App Store or Google Play. In other cases, the local risk assessment application 218 may be a web-based application accessed by a user of the computing device 215, over a network such as network 110 or the Internet.

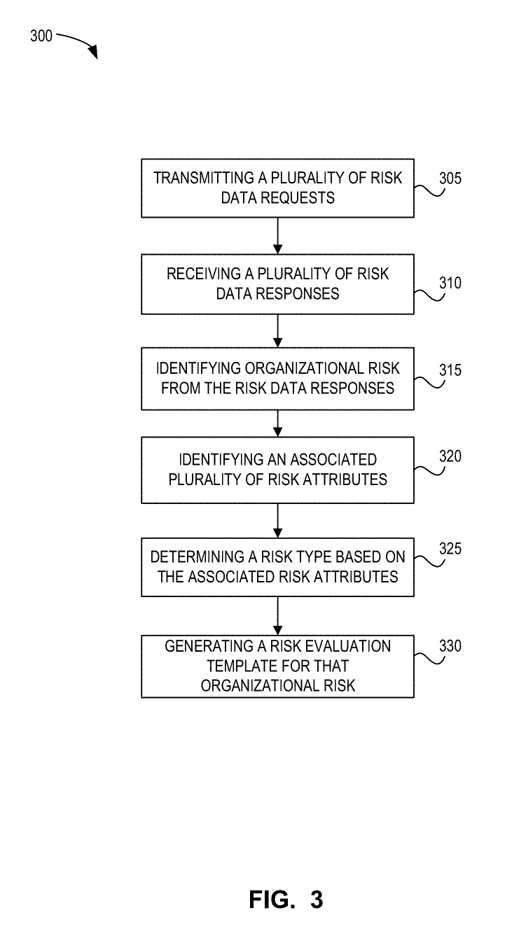

Referring now to FIG. 3, shown therein is a flowchart illustrating a method or process 300 of identifying risk data for an organizational network. Method 300 may be carried out by various components of system 200, such as the RAS 105 and the computing device 215.

At 305, the risk assessment server 105 can transmit a plurality of risk data requests. The risk assessment server 105 can transmit the risk data requests to a plurality of computing devices associated with an organizational network. The risk data requests may be sent to computing devices associated with users whose roles within the organizational network relate to potential risks. The users may then access and respond to the risk data requests using the local risk assessment application 218.

In general, the risk assessment server 105 can direct risk data requests to users identified as being responsible for, or associated with, the oversight of various organizational functions. For example, the users whose roles identify them as being responsible for a particular organizational function may receive the risk data requests. The particular roles and organizational functions can vary based on the size and type of the organizational network 115. Examples of relevant organizational functions can include sales, operations, finance and human resources.

The users may be identified by a user of administrator computer 130. In some cases, the risk assessment server 105 may also identify the users based on user roles identified previously by other similar organizational networks.

Risk data requests may also be directed to users associated with key risk indicator data. In some cases, such users may be automatically prompted to update key risk indicator data at defined intervals.

The risk data requests can include a risk identification template for a user to identify and/or define one or more organizational risks. The template may also provide various attributes fields to allow a user to define risk attributes associated with the organizational risks.

In some cases, the risk identification template may be dynamic to provide a user with access to different attribute fields based on the risk being defined. For example, the risk identification template may include an initial list or drop-down menu of previously identified organizational risks. These previously identified organizational risks may be defined based on data from other organizational networks, an administrator of RAS 105, and/or an administrator user for the organizational network. If the user selects a previously identified organizational risk, the template may be re-configured to provide attribute fields corresponding to that previously identified organizational risk. Examples of attribute fields can include potential risk impact, risk likelihood and risk tolerance related to that risk.

An example of a previously-identified organizational risk is a foreign exchange risk. This risk may relate to potential increases in costs, or reductions in revenue, caused by changes in foreign exchange rates.

In some cases, the risk identification template may also include a new risk definition template. A user may determine that the risk they are identifying does not correspond to any of the previously identified organizational risks. The user may then select the new risk definition template through the local risk assessment application 218. The new risk definition template may include a plurality of pre-defined attribute fields. The new risk definition template may also be re-configured by the user to add additional attribute fields for the organizational risk being defined. This allows the risk management system to provide the organizational network with flexibility to define additional organizational risks, while also provided a streamlined and easy to use risk data collection process.

At 310, the risk assessment server 105 can received a plurality of risk data responses. The risk data responses may corresponds to the data input into the risk identification templates in the risk data request.

Each risk data response can identify a particular organization risk (e.g. a previously identified organizational risk or a user-generated organizational risk). The risk data response can also include a plurality of risk attributes associated with the particular organizational risk.

At 315, the risk assessment server 105 can identify one or more organizational risks from the risk data responses. At 320, the risk assessment server 105 can identify a plurality of risk attributes associated with each organizational risk identified at 315.

The RAS 105 may analyze the organizational risks and corresponding risk attributes received at 310 to identify corresponding organizational risks. The RAS 105 may then identify one or more unique or distinct organizational risks based on this analysis. This may facilitate de-duplication of organizational risks in cases where the same organizational risk is identified in multiple risk data responses.

For example, the RAS 105 may define a risk similarity threshold for identifying corresponding organizational risks. The RAS 105 may then compare the risk attributes in all of the received risk data responses to identify corresponding organizational risks. For instance, the RAS 105 may define risk clusters based on the risk attributes in the received risk data responses and compare the risks within each cluster to one another to determine if they are sufficiently similar to be considered duplicative organizational risks.

In some cases, the RAS 105 may determine that the organizational risks identified in at least two of the risk data responses correspond to the same organizational risk. The RAS 105 identify a particular unique organizational risk by correlating and combining the organizational risks identified in the at least two risk data responses. The risk attributes associated with the particular unique organizational risk can then be defined by combining the risk attributes associated with the organizational risks identified in the at least two risk data responses. In some cases, the RAS 105 may provide a notification to an administrator user to confirm that the duplicative risks identified by RAS 105 should be combined into a single distinct organizational risk.

The RAS 105 may compare the received risk attributes for the organizational risks with the risk attributes of previously identified organizational risks stored in database 238 to determine whether any of the organizational risks are user-generated organizational risks. Thus, the RAS 105 may confirm whether the organizational risks are actually new risks defined by the users, or if they correspond to previously known risks (e.g. to account for differing subject definitions of risk). If the organizational risk is a user-generated organizational risk, the RAS 105 can update the plurality of previously identified organizational risks stored on the database 238 to include the user-generated organizational risk.

The process of identifying organizational risks and risk attributes may be an iterative process. For example, where a risk data response partially defines an organizational risk with attributes that may correspond to multiple previously-known organizational risks, the RAS 105 may prompt one or more of the computing devices to define additional attributes based on the potentially expected attributes of the previously-known organizational risks.

The RAS 105 may also identify additional attributes to be requested for organizational risks identified at 315. Accordingly, the RAS 105 may transmit additional risk data requests to the computing devices 215 to request the additional attributed data.

At 325, the risk assessment server 105 can determine a risk type of each organizational risk based on the associated risk attributes. The risk type or category may define general characteristics of the risk, such as the organizational sectors impacted, e.g. information technology risks, financial risks, legal risks etc. The various risk types may be pre-defined by an administrator user for the organizational network. In some cases, default risk types may be initially defined by RAS 105 and may be updated using the organizational risk assessment application 258 on the administrator computer 120. The risk type identified at 325 may also facilitate the identification of appropriate users for risk evaluation and/or preventative actions.

At 330, the risk assessment server 105 can generate a risk evaluation template for each organizational risk. The risk evaluation template can include a plurality of risk assessment criteria associated with that organizational risk. The RAS 105 can define the plurality of risk assessment criteria based on the risk attributes associated with the organizational risk. The risk assessment criteria may include objective risk assessment criteria as well as subjective risk assessment criteria.

Risk impact attributes may vary for different risk types. Examples of risk assessment criteria related to an expected risk impact can include a technology downtime criterion, a business downtime criterion, a revenue impact criterion, a net income impact criterion, and a reputational impact criterion. For example, a risk of having an internet facing application accessed by a third party may be associated with both a reputational impact criterion and a technology downtime criterion. As another example, a natural disaster risk may be associated with a technology downtime criterion and a business downtime criterion.

Risk likelihood assessment criterion may be defined in terms of estimated probability of the risk occurring. The risk assessment criteria can include subjective user estimates of risk likelihood, such as “rare”, “unlikely”, “possible”, “likely”, “almost certain” for example which may be correlated to a subjective estimate score or rating. The risk assessment criteria may also include historical risk occurrence frequency within the organization. The RAS 105 may also assess various other risk likelihood criteria when evaluating risk likelihood, such as changes to key risk indicator data as risk likelihood data from similar organizational networks.

Risk mitigation assessment criteria may vary based on the types of risks associated with an organizational risk. For example, the risk mitigation assessment criteria may be identified based on risk mitigation processes currently implemented by the organizational network for each risk. The risk mitigation assessment criteria can include an expected mitigation/control effectiveness criteria for each mitigation process currently implemented for a particular risk. In some cases, the RAS 105 may also automatically evaluate some risk mitigation criteria, such as those associated with electronic risk mitigations.

In some cases, the risk evaluation template can be defined based on risk evaluation templates generated for similar organizational risks. For example, where the organizational risk is a newly identified user-generated organizational risk, the RAS 105 may pre-populate, or partially pre-populate the risk evaluation template based on the risk type of that organizational risk. For instance, the RAS 105 may identify risk assessment criteria that are included in the risk evaluation templates for all risks of that risk type and include those assessment criteria in the risk evaluation template.

The RAS 105 may also request additional assessment criteria from an administrator user through the organizational risk application 258. The administrator user may then define additional risk assessment criteria for inclusion in the risk evaluation template.

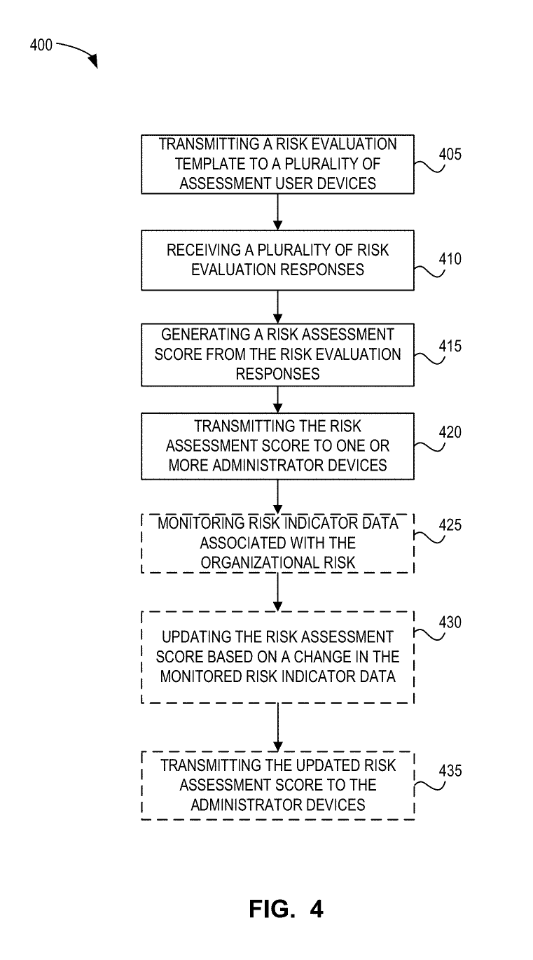

Referring now to FIG. 4, shown therein is a flowchart illustrating a method or process 400 of analyzing risk data for an organizational network. Method 400 may be carried out by various components of system 200, such as the RAS 105 and the computing device 215.

At 405, the RAS 105 can transmit a risk evaluation template for an organizational risk to a plurality of assessment user devices. The risk evaluation template may be defined at step 330 of method 300. As mentioned, examples of risk assessment criteria can include a technology downtime criterion, a business downtime criterion, a revenue impact criterion, a net income impact criterion, and a reputational impact criterion.

The RAS 105 can transmit the risk evaluation template to computing devices 215 associated with assessment users (i.e. assessment user devices) for the organizational network. The RAS 105 may identify the assessment users based on user profile data stored in the database 238. For example, the user profiles stored in the database 238 may include one or more assessment risk types associated with that user profile. The RAS 105 may identify the assessment users as those users whose assessment risk types correspond to the risk type of the organizational risk being assessed.

For instance, the organizational risk type may be a technology risk type (e.g. corresponding to a cybersecurity related risk). User profiles associated with users whose operations within the organization relate to information technology can include a technology risk assessment type. Accordingly, the RAS 105 can transmit the risk evaluation templates for technology type organizational risks to users having access to appropriate data and operations to assess that risk.

The risk assessment users identified by the RAS 105 may vary based on the size and type of the organizational network 115. In general, the risk assessment users may be identified as users responsible for key operational functions within the organizational network such as the heads of sales, operations, finance and human resources. In some cases, these risk assessment users may be identified by a user of administrator computer 130.

At 410, the risk assessment server 105 can receive a plurality of risk evaluation responses from the assessment user devices. The risk evaluation responses can include user-specific values for the plurality of risk assessment criteria defined in the risk evaluation template. For instance, each assessment user may provide a user-specific value for each risk assessment criteria in the risk evaluation template.

At 415, the risk assessment server 105 can generate a risk assessment score based on the risk evaluation responses. The RAS 105 may also use other risk assessment data, such as automatically monitored risk assessment data (e.g. key risk indicator data) and risk assessment data from other organizational networks when generating the risk assessment score.

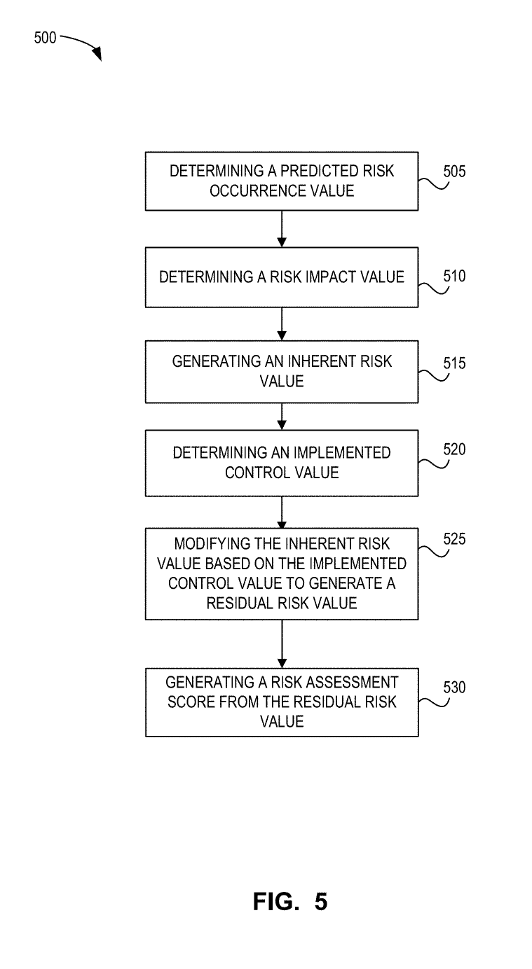

The risk assessment score generally defines an expected organizational impact of an organizational risk. In general, the RAS 105 can automatically generate the risk assessment score for an organizational risk based on the user-specific values in the plurality of risk evaluation responses as well as other risk assessment data, such as benchmark data and key risk indicator data. An example sub-process 500 for generating the risk assessment score is described in further detail below with reference to FIG. 5.

The RAS 105 may also use risk outcome data from other organizational networks (e.g. similar networks) when generating the risk assessment score. For example, the RAS 105 may monitor risk outcome data from a plurality of additional organizational networks. The risk outcome data can define the outcome of previously identified organizational risks associated with that additional organizational network. The RAS 105 can store the risk outcome data in the database 238, along with the user-specific values for those additional organizational networks.

When generating the risk assessment score for a particular organizational risk, the RAS 105 may identify corresponding organizational risks from other organizational networks in the database 238. The RAS 105 may then compare the user-specific values received for the current organizational network and the other organizational networks to identify organizational networks with similar user-specific assessment values. The RAS 105 may then determine the risk assessment score by evaluating the risk outcomes from organizational networks with those similar values.

The RAS 105 may allocate the determined risk assessment scores into one of a plurality of risk levels. For example, the RAS 105 may allocate risk assessment scores into low, medium and high risk levels. In other cases, the RAS 105 may define numerical risk assessment scores, e.g. on a range between 0 and 100 or some other numerical range. The RAS 105 may also define the risk assessment scores using a gradient scoring system, e.g. on a color gradient or using various colors such as red, yellow and green to represent different risk levels.

At 420, the risk assessment server 105 can transmit the risk assessment score generated at 415 to one or more administrator devices associated with the organizational network. The risk assessment score may then be displayed to the administrator user through the organizational risk application to allow the user to assess current risk levels, and determine potential preventative actions to undertake. Examples of user interfaces displaying risk assessment scores and related risk data are shown in FIGS. 7-9 described herein below.

The RAS 105 may also store a risk tolerance for each of the organizational risks associated with the organizational network in database 238. The risk tolerance may be identified by an administrator user through the organizational risk application 238. The RAS 105 may compare each of the risk assessment scores determined at 415 to the corresponding risk tolerance stored for that organizational network.

The RAS 105 may identify one or more organizational risks having a risk assessment score that exceeds (i.e. is riskier than) the stored risk tolerance. The RAS 105 may identify such organizational risks as risky organizational risks. The RAS 105 may then transmit a high risk notification to the administrator device 120 to notify the administrator user of the risky organizational risk. This may prompt the administrator user to initiate one or more preventative actions and/or adjust the risk tolerance for that organizational risk.

The RAS 105 can also store each of the risk assessment scores determined at 415 in the database 238. The RAS 105 may update (e.g. on a periodic basis, in response to changes in risk data, and/or in response to an update request from an administrator user) the risk assessment scores for the organizational risks associated with the organizational network. The RAS 105 may also store each updated risk assessment score in the database 238.

The RAS 105 may generate a risk assessment score timeline for a particular organizational risk based on the stored risk assessment scores. This may allow the RAS 105 to identify trends in the risk assessment score over time. In some cases, the RAS 105 may automatically generate risk increase notifications when the identified trends indicate an increasing level of risk. The risk increase notifications can be sent to an administrator user to allow the user to implement preventative actions even before risk assessment scores exceed risk tolerances.

In some cases, the risk assessment server 105 can identify risk indicators and risk indicator data associated with an organizational risk. The risk assessment server 105 can use the risk indicator data to modify or update the risk assessment score generated at 415.

In general, risk indicators and risk indicator data refers to data that is correlated with the risk scores assigned to particular organizational risks. For instance, risk indicators may include underlying risk factors that influence the likelihood of a risk occurring and/or the organizational impact that may result from that risk occurring (these may be referred to as causal risk indicators or underlying risk indicators). The risk indicators may also include lagging risk indicators that reflect the status of the underlying risk factors.

The RAS 105 can identify, for at least one organizational risk, a plurality of risk indicators associated with that risk. For example, where the organizational risk relates to financial risk associated with a change in a particular exchange rate or rates, the underlying risk factors can include the number of organizational agreements or activities that involve those exchange rates. The lagging risk indicators may include data extracted from financial market data sources indicating that the particular exchange rates have changed. The RAS 105 may monitor risk indicator data to identify changes in risk indicator data and update risk assessment scores on an ongoing basis.

For example, an organizational network 115 may operate applications that face the internet. Accordingly, the RAS 105 may automatically monitor the internet firewall of the organizational network 115 for attempts by third parties to access the application by attempting to penetrate the firewall. The risk assessment server 105 may be set to count the number of third party attempts to penetrate the firewall and trigger an alert when the number of incidents hits various thresholds set by the organization.

The RAS 105 can then identify one or more computing devices associated with the identified risk indicators. The RAS 105 may identify computing devices storing data associated with the identified risk indicators, and store a risk indicator association for those computing devices in database 238. The RAS 105 may then remotely retrieve the risk indicator data from those computing devices 215 through the local risk assessment application 218.

At 425, the risk assessment server 105 can monitor the risk indicator data associated with an organizational risk. The RAS 105 may monitor the risk indicator data on an ongoing basis (e.g. intermittently or periodically).

The RAS 105 may remotely retrieve risk indicator data stored on one or more computing devices using the local risk assessment application. In some cases, the local risk assessment application 238 may transmit the risk indicator data only if there is a change in the risk indicator data. That is, the local risk assessment application 238 on the computing devices may determine that the locally stored risk indicator data has changed, and then transmit this data to the RAS 105 without requiring prompting by RAS 105. The RAS 105 may store this risk indicator data in the database 238. As updated risk indicator data is retrieved, the RAS 105 may identify changes in the risk indicator data by comparing the received risk indicator data with previously stored risk indicator data.

In some cases, the RAS 105 may also identify offline risk indicator data associated with a risk indicator. Offline risk indicator data may refer to risk indicator data that is not stored on a computing device within the organizational network. For example, offline key risk indicators could include monitoring of the number of complaint calls at an inbound call center, or an organization's social media scores. Such key risk indicators may provide a leading indicator of changes in customer sentiment and service levels towards the organizational network 115, which may in turn affect future revenue growth. The RAS 105 can identify users associated with the offline risk indicator data and store that association in database 238. For instance, an administrator user may identify users associated with offline risk indicator data using organizational risk assessment application 258. In some cases, the RAS 105 may also identify users associated with offline risk indicator data based on user roles within the organizational network.

The RAS 105 can transmit a risk indicator data request to the computing device 215 corresponding to each user associated with offline risk indicator data. The RAS 105 can automatically generate risk indicator data requests on an ongoing (e.g. periodic) basis to ensure that the stored risk indicator data is up to date.

The risk indicator data request can identify the associated risk indicator and define the requested risk indicator data. A user can then provide the requested risk indicator data in a risk indicator data response through the local risk assessment application 218.

The RAS 105 can store and monitor the offline risk indicator data in a similar manner as with the automatically collected risk indicator data. The RAS 105 can also detect changes in the offline risk indicator data as compared to previously-retrieved offline risk indicator data.

At 430, the risk assessment server 105 can update the risk assessment score generated at 415 the risk indicator data detected by the monitoring at 425. For example, the RAS 105 may automatically update the risk assessment scores when a change is identified in the retrieved risk indicator data. This may ensure that the risk assessment scores for the various organizational risks accurately reflect current organizational risk levels.

At 435, the risk assessment server 105 can transmit the updated risk assessment score from 430 to the administrator devices associated with the organizational network. The updated risk assessment score can provide an administrator with real-time data reflecting current levels of organizational risks. In some cases, the updated risk assessment score may be transmitted to the administrator user only if the RAS 105 determines that the defined risk level has changed.

Referring now to FIG. 5, shown therein is a flowchart illustrating a method or process 500 of generating a risk assessment score. Method 500 may be carried out by various components of system 200, such as the RAS 105 and the computing device 215.

At 505, the risk assessment server 105 can determine a predicted risk occurrence value for the organizational risk. The predicted risk occurrence value can be determined as an estimated likelihood of that organizational risk occurring. The RAS 105 may assign the predicted risk occurrence value to a risk occurrence level (e.g. low, medium, high or other similar arrangement of categories) or assign a numerical value for the predicted risk occurrence value.

The RAS 105 may determine the predicted risk occurrence value based on the user-specific responses received in the risk evaluation responses received at 410. Each risk assessment user may provide estimated risk occurrence responses based on risk likelihood criteria in a risk assessment template. The risk likelihood criteria may be defined by a user of administrator computer 130.

In some cases, the RAS 105 may compare the user-specific responses to responses received for similar organizational networks. The RAS 105 may identify similar organizations having similar risk evaluation responses at some point in time. The RAS 105 may then analyze the risk outcome data associated with those similar organizations to determine the predicted risk occurrence value. The RAS 105 may then identify the predicted risk occurrence value based on benchmark risk occurrence data generated from the risk outcomes of similar organizational networks.

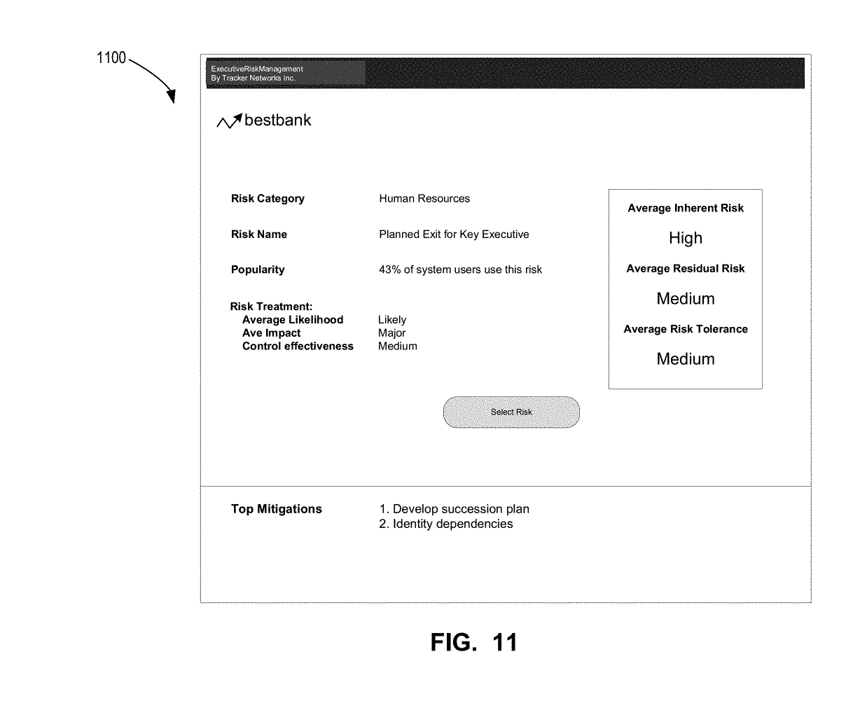

The RAS 105 may also identify preventative actions put in place by those similar organizations (at the point in time at which those organizations had similar risk evaluation responses or afterwards). The RAS 105 may adjust the predicted risk occurrence value for the current organizational network based upon the presence or absence of such preventative actions. The RAS 105 may also define a combined mitigation effectiveness based on the identified preventative actions. The RAS 105 may associate each preventative action with an effectiveness score based on the risk outcome data from similar organizational networks. The effectiveness scores for the identified preventative actions may then be combined (e.g. added or multiplied) to generate the combined mitigation effectiveness. The RAS 105 may adjust the predicted risk occurrence value based on this combined mitigation effectiveness score. In some cases, the RAS 105 may also identify suggested preventative actions (mitigations) that may reduce the predicted risk occurrence value and/or risk impact as shown in FIG. 11 described herein below.

At 510, the risk assessment server 105 can determine a risk impact value for the organizational risk. The predicted risk impact value can be determined as an estimated organizational impact of that organizational risk occurring (i.e. what the impact would be if the risk came to pass). The RAS 105 may assign the risk impact value to a risk occurrence level (e.g. low, medium, high or other similar arrangement of categories) or assign a numerical value for the predicted risk occurrence value.

For example, a business interruption organizational risk may be identified. This organizational risk may be defined as a business interruption that prevents the organizational network from generating revenue for a period of time, e.g. a hurricane shutting down a sales and distribution center. The RAS 105 may define the risk impact value of this risk occurring based on an estimate of the revenue and profitability lost from the shutdown, costs of recovery, and the estimated reputational damage.

As with the predicted risk occurrence value determined at 505, the RAS 105 may determine the risk impact value based on the user-specific responses received in the risk evaluation responses received at 410. The RAS 105 may compare the user-specific responses to responses received for similar organizational networks. The RAS 105 may then analyze the risk outcome data associated with those similar organizations to determine the risk impact value for the organizational risk.

At 515, the risk assessment server 105 can generate an inherent risk value from the predicted risk occurrence value determined at 505 and the risk impact value determined at 510.

For example, the inherent risk value may be determined simply as an addition or multiplication of the predicted risk occurrence value determined at 505 and the risk impact value determined at 510.

In other cases, the RAS 105 may store a mapping in the database 238 between pairs of predicted risk occurrence values and risk impact values and inherent risk values. The RAS 105 may then determine the inherent risk value based on this mapping.

At 520, the risk assessment server 105 can determine an implemented control value for the organizational risk. The implemented control value may indicate a level of organizational control implemented within the organizational network to prevent the occurrence of that risk.

The risk assessment criteria included in the risk evaluation template sent to assessment users may include one or more risk control criteria. For example, the risk evaluation template may identify a plurality of potential risk controls (e.g. based on preventative actions from similar organizational networks). The risk evaluation template may include a simple check box or drop-down menu to allow an assessment user to identify if those preventative actions have been implemented. As mentioned, the risk assessment criteria may also include various objective and subjective risk mitigation assessment criteria. The RAS 105 may determine the implemented control value based on the responses related to the risk mitigation assessment criteria. The RAS 105 may associate each preventative action with an effectiveness score based on the received responses and/or risk outcome data from similar organizational networks. The effectiveness scores for the identified preventative actions may then be combined (e.g. added or multiplied) to generate the implemented control value as a combined mitigation effectiveness.

At 525, the risk assessment server 105 can modify the inherent risk value from 515 using the implemented control value to generate a residual risk value.

The residual risk value may represent the risk level associated with the organizational risk even after control processes have been implemented. For example, the implemented control value may be subtracted from the inherent risk value or the inherent risk value may be divided by the implemented control value to define the residual risk value.

At 530, the risk assessment server 105 can generate the risk assessment score for the organizational risk from the residual risk value. In some cases, the risk assessment score can be generated simply as the numerical value of the residual risk value. In other cases, the RAS 105 may assign the risk assessment score to a risk level (e.g. low, medium, high, critical) to provide a simple risk assessment score for an administrator user. This may provide the administrator user with an easy to understand risk assessment score that allows them to implement preventative actions appropriately.

As a simplified example, the RAS 105 may define the risk occurrence value (at 505), the risk impact value (at 510), and the implemented control value (at 520) on a scale from 1 to 10. The RAS 105 may then determine an inherent risk value by multiplying the risk occurrence value by the risk impact value. The inherent risk value may then be defined on a scale from 1 to 100. For instance, if the risk occurrence value is determined to be 5 and the risk impact value is determined to be 6, the RAS 105 may determine that the inherent risk value is 30. If the implemented control value is determined to be 2, the RAS 105 may then determine the residual risk value by dividing the inherent risk value of 30 by 2, resulting in a residual risk value of 15/100.

As another example, the RAS 105 may provide a single combined calculation to determine a residual risk value. The RAS 105 may determine that the preventative actions reduce the risk impact value and accordingly, the RAS 105 may reduce the risk impact value by the implemented control value (i.e. 6−2=4 given the values set out above). The residual risk value may then be determined by multiplying the reduced risk impact value of 4 by the risk occurrence value of 5 to obtain a residual risk value of 20/100. The particular calculation may be determined by the RAS 105 based on risk outcomes from similar organizational networks.

As another simplified example, an organizational network 115 may operate one or more applications that face the Internet. The RAS 105 may determine that the organizational network 115 has an organizational risk of a third party obtaining unauthorized access to the application, e.g. using “hacking” techniques or as a result of application security flaws.

The impact of such a risk may relate to the organizational network 115 losing application data and potentially confidential data. Accordingly, the risk impact criteria may include a net income criterion (e.g. evaluating potential losses associated with losing the application data) and a reputational impact criterion (e.g. evaluating the potential reputational impact to the organizational network of the application and confidential data being lost). The risk likelihood criteria may include subjective criteria, such as the prevalence of application data breaches in the appropriate organizational sector, historical frequency, and perceived threats to the organizational network 115.

The organizational network 115 may have implemented a number of risk mitigation processes, such as user authentication processes and data encryption processes. The RAS 105 may evaluate aspects of these risk mitigation processes automatically, e.g. by comparing such risk mitigation processes to authentication and encryption protocols implemented by similar organizational networks. The RAS 105 may also include risk mitigation assessment criteria on the risk evaluation template, in which appropriate assessment users evaluate the level of adherence to the organizational protocols.

The RAS 105 may determine, based on the received risk evaluation responses, that the inherent risk level is high. The RAS 105 may also provide a score associated with the inherent risk, e.g. an expected $10 million dollar impact. The RAS 105 may determine from evaluating the risk mitigation processes implemented, and the corresponding response regarding risk mitigation criteria that the organizational network 115 has implemented relatively strong mitigation processes. Accordingly, the residual risk level may be reduced to a medium level (e.g. associated with an expected $5 million dollar impact) or a low risk level (e.g. associated with an expected $1 million dollar impact).

The RAS 105 can also generate inherent risk values, residual risk values and risk assessment scores for a plurality of organizational networks. The risk values generated for the organizational network can be used to define benchmark risk values (e.g. as a mean value or median value) for certain organizational risks. In some cases, the RAS 105 may also identify benchmark risk tolerance values. This may allow administrator users to determine how the risks for their organizational networks compare to other, similar, organizational networks. This may provide additional insight for those users and allow them to determine whether their current risk assessment score appears appropriate for their type of organizational network.

The RAS 105 may also identify preventative actions associated with positive risk outcome data and lower risk assessment scores. The RAS 105 may display these preventative actions to an administrator user as suggested preventative actions. This may allow an administrator user to quickly and easily implement preventative actions knowing that those preventative actions have been associated with positive risk outcomes.

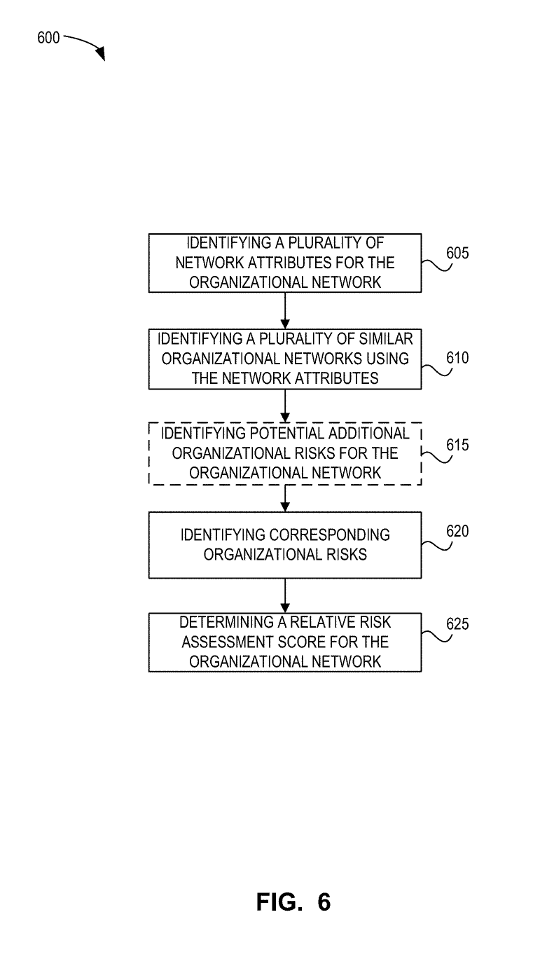

Referring now to FIG. 6, shown therein is a flowchart illustrating a method or process 600 of analyzing risk data for a plurality of organizational networks. Method 500 may be carried out by various components of system 200, such as the RAS 105 and the computing device 215.

At 605, the risk assessment server 105 can determine a plurality of network attributes for the organizational network. The network attributes can include objective attributes such as an organization size, an organization industry or sector, and an organization age. The network attributes may also include an estimated risk maturity determined by the RAS 105. The risk maturity may indicate the extent of previous risk monitoring performed by the organizational network. For instance, the RAS 105 may initially assign the organizational network a low estimated risk maturity by default.

At 610, the risk assessment server 105 can identify a plurality of similar organizational networks using the network attributes from 605. The database 238 can store organizational profiles corresponding to a plurality of organizational networks. Each organizational profile can include the network attributes for that organizational network. The RAS 105 may compare the network attributes for the particular organizational network with the network attributes of other networks stored in the organizational profiles. The RAS 105 may then determine one or more similar organizational networks by identifying networks having similar organizational profiles

In some cases, the RAS 105 may assign each organizational network an organization category. For example, an organization may be assigned to a category defined as large-size business-to-business service organizations. The RAS 105 may then identify similar networks based on these organization categories.

Optionally, at 615, the risk assessment server 105 can identify potential additional risks for the organizational network based on risk data for the similar organizational networks. For example, the RAS 105 may identify previously identified organizational risks associated with the similar organizational networks that are stored in the database 238. The RAS 105 can compare these previously identified organizational risks with the risks currently identified for the organizational network in question.

The RAS 105 may identify potential additional organizational risks as the previously identified organizational risks from other networks that were not identified for the network in questions. The RAS 105 may then transmit a notification to the administrator computed 120 identifying the at least one potential additional organizational risk. This may also the administrator user to determine if the potential additional risk is relevant to the organizational network. If the additional risk is relevant, administrator user may then initiate the process of collecting and analyzing relevant risk data using the organizational risk application 258.

At 620, the risk assessment server 105 can identify corresponding organizational risks at the organizational network and similar organizational networks. That is, the RAS 105 can identify which other, similar, organizations have previously identified, assessed and monitored the same organizational risks.

At 625, the risk assessment server 105 can determine a relative risk assessment score for the organizational network. The RAS 105 can compare the risk assessment score for the organizational network with the current risk assessment scores for other, similar organizational networks. The RAS 105 may generate a relative risk score for the organizational network indicating whether the organizational network is at greater or lesser risk than similar organizational networks. For instance, the RAS 105 may determine an average risk assessment score for similar organizational networks. The RAS 105 may then define the relative risk assessment score as compared to that average score.

The RAS 105 can transmit the determined relative risk assessment score to the administrator computer 120. This may allow an administrator to determine the organizational network's risk levels relative to comparable organizations and provide additional context for determining whether to undertake preventative actions.

The RAS 105 may also provide additional comparative risk data to the administrator user. For example, the comparative risk data may also include the most common and/or most effective preventative actions determined from the similar organizations. An example of a user display showing comparative risk data is shown in FIG. 11 described herein below.

Referring now to FIG. 7, shown therein is an example organizational risk overview display GUI 700. GUI 700 may be displayed to an administrator user through organizational risk assessment application 258.

GUI 700 provides an administrator user with an overview of risks identified for the organizational network as well as related risk data. As shown in FIG. 7, GUI 700 also provides the administrator user with an overview of predicted risk occurrence values, risk impact values, inherent risk values, implemented control values and organizational risk tolerances. The GUI 700 also identifies the risk categories associated with the various organizational risks, as well as whether any preventative actions are in progress or have been addressed.

GUI 700 provides a summary for a plurality of the organizational risks identified for the organizational network. As GUI 700 illustrates, the organizational risks may be broken down into categories of risk scores, such as high risk, medium risk, and low risk. The organizational risk assessment application also provides the administrator with the ability to drill down to view organizational risks and related risk data. A user may select one of the organizational risks listed in GUI 700 to access a detailed display of application risk information.

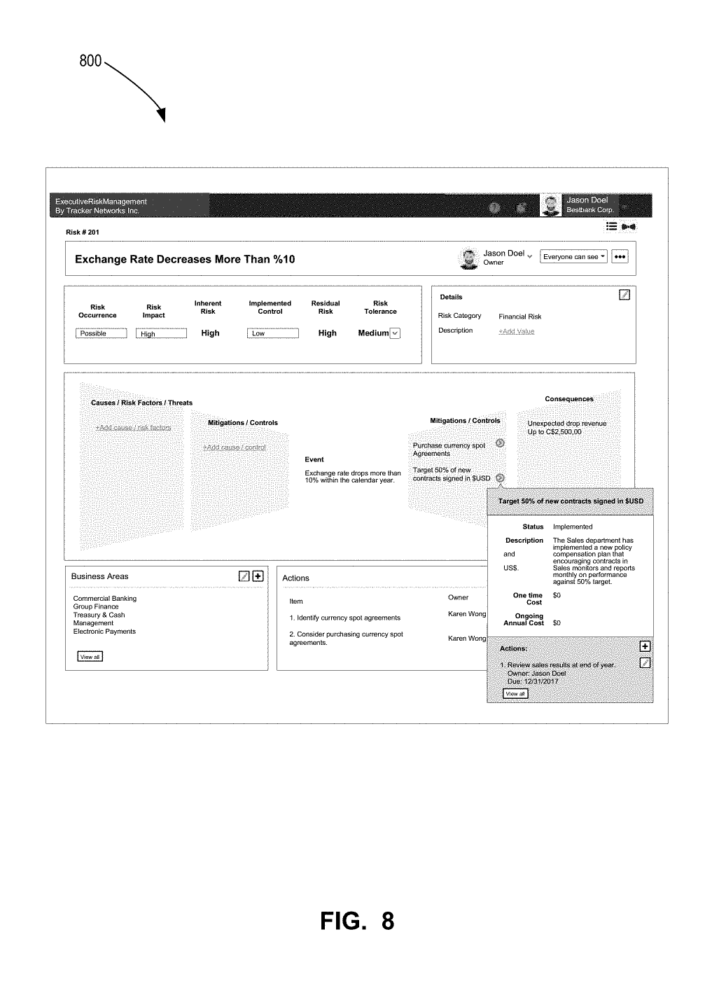

Referring now to FIG. 8, shown therein is an example of a detailed risk display GUI 800 in accordance with an embodiment. The detailed risk display GUI 800 may display detailed risk data associated with a particular organizational risk to an administrator user. GUI 800 is an example GUI that may be displayed to an administrator user after selecting an organizational risk listed in GUI 700.

The GUI 800 also displays risk indicator data (e.g. causal risk factors) associated with the organizational risk as well as preventative actions that have been implemented for that organizational risk. An administrator user may select one of the preventative actions to review details of its implementation and status. The GUI 800 may also identify users whose organizational functions are associated with that risk and thus may be suitable to evaluate that risk.

As shown in FIG. 8, GUI 800 may also enable an administrator user to adjust various organizational risk settings, such as the risk tolerance. In some cases, the administrator user may also be enabled to define or re-define the associated risk category and or organizational areas for the organizational risk. The administrator user may also adjust the permissions level required to review and assess the organizational risk through GUI 800.

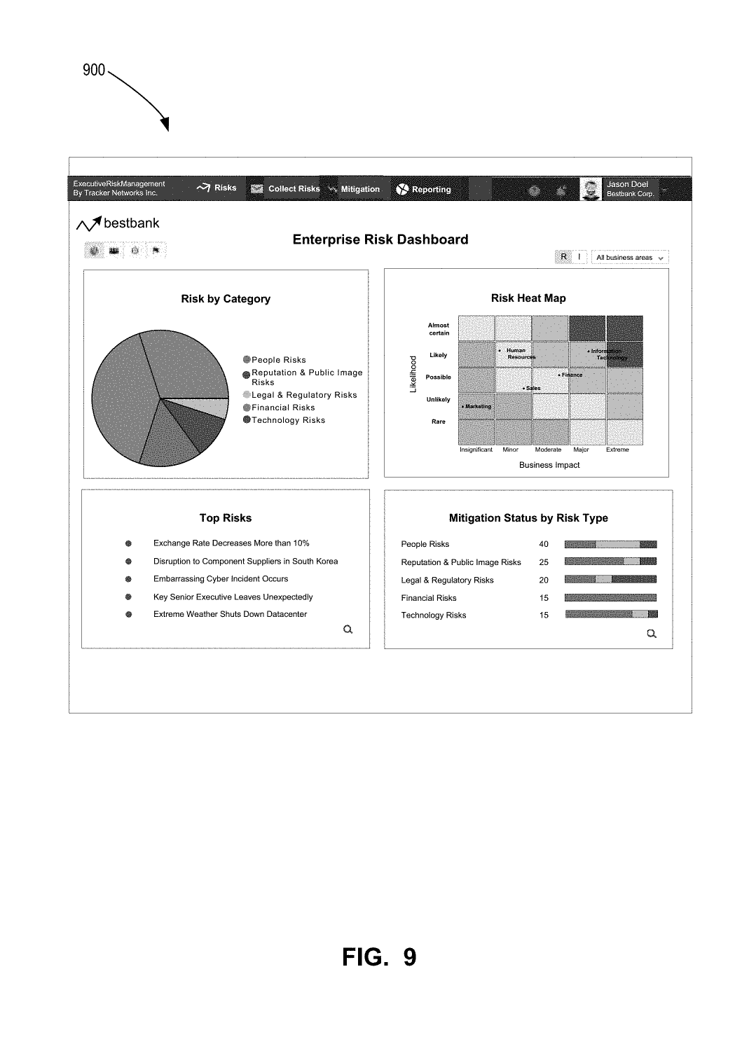

Referring now to FIG. 9 shown therein is an example of a network risk overview display 900 that may be displayed in accordance with an example embodiment. The network risk overview display 900 may form part of an organization risk portal that may be provided by the organizational risk assessment application 258.

The GUI 900 may provide administrator and corporate users with an overview of the risk levels and risk allocation of organizational risks within that network. The network risk overview GUI may include various, high-level, risk overview displays such as risk registers, risk heat maps, outstanding action reports, risk trending reports that may be useful for reporting to internal users such as executive management and or the Board of Directors.

Referring now to FIG. 10A, shown therein is an example risk data request GUI 1000. The risk data request GUI 1000 is an example of a GUI that may be displayed to a user through local risk assessment application 218. The RAS 105 may transmit a risk data request to users to identify organizational risks and associated risk data. The risk data request GUI 1000 may then provide those users with a link to a risk data response template. As shown in FIG. 10, the GUI 1000 may also be used to request updated risk data or risk indicator data associated with an organizational risk.

Referring now to FIG. 10B, shown there is an example of a risk data response GUI 1050. The risk data response GUI 1050 is an example of a partially complete risk data response generated in response to the risk data request. A user can select, or adjust, various attribute fields, such as adjusting the preventative action status from “In Process” to “Completed”. The user may also input additional, free-form risk data into the note box shown in GUI 1050.

Referring now to FIG. 11, shown therein is an example of a comparative risk score GUI 1100. The GUI 1100 provides an administrator user with benchmark data associated with a particular organizational risk. As shown in FIG. 11, the benchmark data may be determined based on the average values from similar organizational networks stored in database 238. This benchmark data may provide an administrator user with context to determine whether their current organizational risk levels appear to be appropriate.

The GUI 1100 can also include some suggested or “top” preventative actions/mitigation processes. These suggested preventative actions can be determined based on preventative actions implemented by similar organizational networks with positive risk outcomes. This may provide an administrator user with insight into methods of managing the organizational risk and potentially reducing the associated risk level.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

We claim:

1. A method of analyzing risk data for an organizational network, the method comprising:
providing a risk assessment server for monitoring organizational risk, the risk assessment server comprising a processor and a memory and being in communication with a plurality of computing devices associated with the organizational network including a plurality of user devices;
transmitting, by the risk assessment server, a risk data request to each of the user devices in the plurality of user devices;
receiving, by the risk assessment server a plurality of risk data responses from the user devices, each risk data response identifying a particular organizational risk and defining a plurality of risk attributes associated with the particular organizational risk;
for at least one of the particular organizational risks, defining by the risk assessment server, a risk assessment score by
generating, by the risk assessment server, a risk evaluation template for that particular organizational risk, the risk evaluation template defining a plurality of risk assessment criteria based on the plurality of risk attributes associated with that particular organizational risk;
transmitting, by the risk assessment server, the risk evaluation template to a plurality of assessment user devices in the plurality of users devices;
receiving, by the risk assessment server from the plurality of assessment user devices, a plurality of risk evaluation responses, each risk evaluation response including user-specific values for the plurality of risk assessment criteria in the risk evaluation template;
automatically generating, by the risk assessment server, a risk assessment score for the particular organizational risk based on the user-specific values in the plurality of risk evaluation responses, the risk assessment score defining an expected organizational impact of that particular organizational risk; and
transmitting the risk assessment score for the particular organizational risk to at least one of the user devices.

2. The method of claim 1, wherein automatically generating the risk assessment score comprises:
determining a predicted risk occurrence value from the user-specific values in the plurality of risk evaluation responses, the predicted risk occurrence value indicating an estimated likelihood of that organizational risk occurring;
determining a predicted risk impact value from the user-specific values in the plurality of risk evaluation responses, the predicted risk impact value indicating an estimated organizational impact of that organizational risk occurring;
generating an inherent risk value from the predicted risk occurrence value and the predicted risk impact value;
determining an implemented control value from the user-specific values in the plurality of risk evaluation responses, the implemented control value indicating a level of organizational control implemented to prevent the occurrence of that organizational risk;
modifying the inherent risk value based on the control value to generate a residual risk value; and
generating the risk assessment score from the residual risk value.

3. The method of claim 1, wherein the risk assessment server is configured to store a risk tolerance for each of the particular organizational risks in the memory, and the method further comprises:
comparing, by the risk assessment server for each particular organizational risk, the risk assessment score determined for that particular organizational risk and the stored risk tolerance;
identifying, by the risk assessment server, a risky organizational risk as an organizational risk in the at least one particular organizational risk having a risk assessment score that exceeds the stored risk tolerance for that organizational risk;
transmitting a high risk notification to the at least one user device, the high risk notification identifying the risky organizational risk.

4. The method of claim 1, further comprising, for at least one of the particular organizational risks:
identifying, by the risk assessment server, a plurality of risk indicators;
for at least one of the risk indicators
identifying, by the risk assessment server, one or more computing devices in the plurality of computing devices that stores risk indicator data associated with that risk indicator;
remotely monitoring, by the risk assessment server, the stored risk indicator data on the one or more computing devices;
identifying, by the risk assessment server, a change in the risk indicator based on the monitoring;
automatically adjusting, by the risk assessment server, the risk assessment score for the particular organizational risk in response to the identified change in the risk indicator; and
transmitting the adjusted risk assessment score to the at least one of the user devices.

5. The method of claim 4, further comprising, for a second risk indicator:
identifying, by the risk assessment server, one or more users associated with risk indicator data for that second risk indicator;
for each of the one or more users identified, repeatedly transmitting, by the risk assessment server to a user device associated with that user, a risk indicator data request identifying the second risk indicator and defining the requested risk indicator data;
receiving, by the risk assessment server, a risk indicator data response from the user device associated with at least one of the one or more users;
identifying, by the risk assessment server from the received risk indicator data response, a change in the second risk indicator;
automatically adjusting, by the risk assessment server, the risk assessment score for the particular organizational risk in response to the identified change in the second risk indicator; and
transmitting the adjusted risk assessment score to the at least one of the user devices.

6. The method of claim 1, wherein:
the risk assessment server is in communication with at least one database storing a plurality of previously identified organizational risks;
the risk data request identifies at least some of the previously identified organizational risks and provides a new risk definition template; and
the particular organizational risk identified in one of the risk data responses received by the risk assessment server is a user-generated organizational risk that does not correspond to any of the previously identified organizational risks defined using the new risk definition template.

7. The method of claim 6, further comprising updating, by the risk assessment server, the plurality of previously identified organizational risks stored on the database to include the user-generated organizational risk.

8. The method of claim 6, further comprising:
determining, by the risk assessment server, a risk type of the user-generated organizational risk based on the plurality of risk attributes associated with that user-generated organizational risk;
determining, by the risk assessment server, that the determined risk type is also associated with at least one of the previously identified organizational risks; and
pre-populating, by the risk assessment server, some of the risk assessment criteria in the risk evaluation template for that user-generated organizational risk based on the determined risk type.

9. The method of claim 1, further comprising:
identifying, by the risk assessment server, at least one unique organizational risk from the plurality of risk data responses by:
determining, by the risk assessment server, that the particular organizational risks identified in at least two of the risk data responses correspond to the same organizational risk; and
identifying a particular unique organizational risk by correlating the organizational risks identified in the at least two risk data responses whereby the risk attributes associated with the particular unique organizational risk are defined by combining the risk attributes associated with the organizational risks identified in the at least two risk data responses; and
wherein the at least one of the particular organizational risks for which a risk assessment score is defined is determined based on the at least one unique organizational risks identified.

10. The method of claim 1, wherein the risk assessment server is in communication with at least one database storing user profiles associated with the user devices, and the method further comprises, for each particular organizational risk:
determining, by the risk assessment server, a risk type of that particular organizational risk based on the plurality of risk attributes associated with that particular organizational risk; and
identifying the plurality of assessment user devices for that particular organizational risks by identifying user profiles associated with that determined risk type.

11. The method of claim 1, wherein generating the risk assessment score for the identified organizational risk comprises weighting the plurality of risk evaluation responses based on a user weighting associated with each of the corresponding assessment users.

12. The method of claim 1, wherein the risk assessment server is in communication with a plurality of additional organizational networks, and the method further comprises:
receiving, by the risk assessment server from each of the additional organizational networks, risk outcome data defining an outcome of previously identified organizational risks associated with that additional organizational network;
determining that at least one of the particular organizational risks corresponds to one of the previously identified organizational risks; and
wherein generating the risk assessment score for the at least one of the particular organizational risks is based on risk outcome data associated with the corresponding previously identified organizational risks from the additional organizational networks.

13. The method of claim 1, wherein the risk assessment server is in communication with a plurality of additional organizational networks and at least one database storing organizational profiles corresponding to the organizational network and each of the additional organizational network, and the method further comprises:
determining, by the risk assessment server, at least one similar organizational network from the plurality of additional organizational networks from the organizational profiles, each similar organizational network having an organizational profile similar to that of the organizational network;
determining, by the risk assessment server for at least one of the particular organizational risks, a similar network risk assessment score for that particular organizational risk in each of the similar organizational networks;
determining, by the risk assessment server for the organizational network, a relative risk assessment score for the at least one particular organizational risk by comparing the generated risk assessment score and the determined similar network risk assessment scores; and
transmitting the relative risk assessment score to the at least one of the user devices.

14. The method of claim 1, wherein the risk assessment server is in communication with a plurality of additional organizational networks and at least one database storing organizational profiles corresponding to the organizational network and each of the additional organizational network, and the method further comprises:
determining, by the risk assessment server, at least one similar organizational network from the plurality of additional organizational networks from the organizational profiles, each similar organizational network having an organizational profile similar to that of the organizational network;
identifying, by the risk assessment server for the organizational network, at least one potential additional organizational risk based on previously identified organizational risks associated with the similar organizational networks; and
transmitting the at least one potential additional organizational risk to the at least one user device.

15. The method of claim 1, further comprising:
storing the risk assessment score for each of the particular organizational risks in the memory;
repeatedly updating, by the risk assessment server, the risk assessment score defined for the at the at least one particular organizational risk; and
storing each updating risk assessment score in the memory.
